(19) United States
(12) Patent Application Publication
(10) Pub. No.: US 2011/0247004 A1
(43) Pub. Date: Oct. 6, 2011

(54) Information Processing Apparatus

(76) Inventor: Fumikazu Matsukawa, Koganei-shi (JP)

(21) Appl. No.: 13/008,693

(22) Filed: Jan. 18, 2011

(30) Foreign Application Priority Data
Mar. 30, 2010 (JP) 2010-079855

(51) Int. Cl. G06F 9/50

(52) U.S. Cl. 718/104

(57) ABSTRACT

According to one embodiment, an information processing apparatus is provided. The information processing apparatus which performs a signaling process with an external apparatus through a network and a multimedia process of data, includes: first and second CPU cores each including one or more CPU cores; a first controller configured to allocate one of the signaling process and the multimedia process to the first CPU core, and the other of the signaling process and the multimedia process to the second CPU core; and a second controller configured to allocate a process which is different from the multimedia process and the signaling process to one of the first and second CPU cores, according to process states of the first and second CPU cores.

### CROSS REFERENCE TO RELATED APPLICATION(S)

The application is based upon and claims the benefit of priority from Japanese Patent Application No. 2010-079855 filed on Mar. 30, 2010; the entire contents of which are incorporated herein by reference.

### FIELD

Embodiments described herein relate generally to an information processing apparatus.

### BACKGROUND

In a VoIP communication system, a VoIP server performs a signaling process related to a communication protocol between a terminal and a server, and related to a control signal, and performs a multimedia process such as encoding/decoding of audio and video data. These processes are requested to have a high real-time property. In the case where these processes are performed by a single CPU or CPU core, when a load of one of the processes is increased, there is a possibility that the other process may be constrained. Preferably, therefore, a multimedia process and a signaling process are performed by different CPUs or CPU cores, so that the processes are not mutually affected by the respective process loads.

In a VoIP server, a process load of a CPU core is varied depending on a state of a process which is performed by the CPU. Therefore, it is preferred to dynamically allocate processes to the CPU core in accordance with the process state, whereby the process load of the CPU core can be suppressed.

### BRIEF DESCRIPTION OF THE DRAWINGS

FIG. 1 is a diagram showing an example of a usage form of a VoIP server of a first embodiment.

FIG. 2 is a diagram showing an example of a system configuration of the VoIP server.

FIG. 3 is a view showing an example of a data configuration of priority information in the first embodiment.

FIG. 4 is a view showing an example of a data configuration of allocation information in the first embodiment.

FIG. 5 is a view showing an example of a data configuration of threshold information in the first embodiment.

FIG. 6 is a chart showing an example of a process flow of production of the allocation information in the VoIP server.

FIG. 7 is a chart showing an example of a process flow of a process of allocating a CPU core which is to perform a process, in the VoIP server.

FIG. 8 is a chart showing an example of a process flow of an allocation core determining process, in the VoIP server.

FIG. 9 is a chart showing another example of the process flow of the allocation core determining process.

FIG. 10 is a chart showing a further example of the process flow of the allocation core determining process.

FIG. 11 is a chart showing an example of a process flow of production of allocation information in a VoIP server of a second embodiment.

FIG. 12 is a chart showing an example of a process flow of a process of allocating a CPU core which is to perform a process, in the VoIP server of the second embodiment.

### DETAILED DESCRIPTION

In general, according to one embodiment, an information processing apparatus is provided. The information processing apparatus which performs a signaling process with an external apparatus through a network and a multimedia process of data, includes: first and second CPU cores each including one or more CPU cores; a first controller configured to allocate one of the signaling process and the multimedia process to the first CPU core, and the other of the signaling process and the multimedia process to the second CPU core; and a second controller configured to allocate a process which is different from the multimedia process and the signaling process to one of the first and second CPU cores, according to process states of the first and second CPU cores.

### First Embodiment

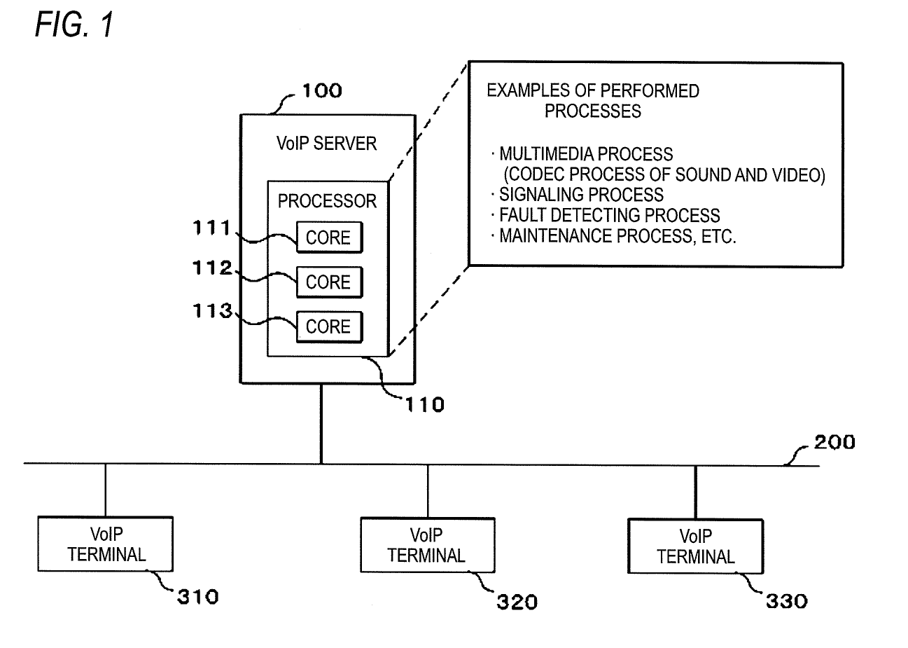

Hereinafter, a first embodiment will be described with reference to FIGS. 1 to 10.

FIG. 1 is a diagram showing a usage form of an information processing apparatus of the first embodiment. For example, the information processing apparatus is realized as a VoIP server 100. The VoIP server 100 includes a CPU 110 containing a plurality of CPU cores, and the like, and is connected to VoIP terminals 310, 320, 330 through a network 200. The VoIP server 100 controls communication (telephone) between the VoIP terminals 310, 320, 330, and performs, for example, a signaling process, a multimedia process, and the like on the VoIP terminals.

The signaling process is a process which is related to a communication protocol between a VoIP terminal and a VoIP server. For example, a process of setting a communication channel for performing communication (telephone) between VoIP terminals, and a process of starting/ending the communication correspond to the signaling process.

The signaling process will be described by exemplifying the case where the VoIP terminals 310, 320 make telephone communication with each other. When receiving a user operation of requesting a call to the VoIP terminal 320, the VoIP terminal 310 transmits an INVITE signal which is a signal requesting session establishment with the VoIP terminal 320, to the VoIP server 100. Upon receiving the INVITE signal, the VoIP server 100 transmits the INVITE signal to the VoIP terminal 320.

When the VoIP terminal 320 receives the INVITE signal from the VoIP server 100, the VoIP terminal 320 performs a calling process of producing a ringing tone, and returns a 180 RINGING message signal indicating that the calling process is currently performed, to the VoIP server 100. On receiving the 180 RINGING message, the VoIP server 100 transmits the 180 RINGING message to the VoIP terminal 310.

When a user reply operation such as an operation of picking up the receiver of the VoIP terminal 320 which is being called is applied to the VoIP terminal 320, the VoIP terminal 320 transmits a 200 OK message which is a response message signal to the VoIP terminal 310, to the VoIP server 100. Upon receiving the 200 OK message, the VoIP server 100 transmits the 200 OK message to the VoIP terminal 310.

Upon receiving the 200 OK message from the VoIP terminal 320, the VoIP terminal 310 transmits an ACK message which is an acknowledge message to the VoIP terminal 320, to the VoIP server 100. Upon receiving the ACK message, the VoIP server 100 transmits the ACK message to the VoIP terminal 320, and, when the VoIP terminal 320 receives the ACK message, exchange (call) of a real-time audio signal between the VoIP terminals 310, 320 is started. The real-time audio signal is transmitted and received by, for example, an RTP protocol.

When, during the call between the VoIP terminals 310 and 320, the VoIP terminal 310 receives a user operation of ending the call, the VoIP terminal 310 transmits a BYE message which is a call end message signal to the VoIP terminal 320, to the VoIP server 100. Upon receiving the BYE message, the VoIP server 100 transmits the BYE message to the VoIP terminal 320. When receiving the BYE message, the VoIP terminal 320 transmits a 200 OK message which is a response message signal to the BYE message, to the VoIP server 100. Upon receiving the 200 OK message, the VoIP server 100 transmits the 200 OK message to the VoIP terminal 310. When the VoIP terminal 310 receives the 200 OK message, the call is ended.

Namely, the VoIP server 100 processes signaling signals such as INVITE, 180 RINGING, 200 OK, ACK, and BYE.

The multimedia process is, for example, a codec process of audio data, video data, or the like. A codec process will be described by exemplifying the case where a telephone conference is held among the VoIP terminals 310, 320, 330. In the telephone conference, each of the VoIP terminals 310, 320, 330 encodes a sound which is input in a microphone unit of the terminal, and transmits the encoded audio data in a form of a packet to the VoIP server 100. When the VoIP server 100 receives the audio data from the VoIP terminals 310, 320, 330, the VoIP server decodes the audio data. The VoIP server 100 mixes a plurality of decoded audio data, encodes the mixed audio data, and then transmits the encoded audio data to the VoIP terminals 310, 320, 330. Namely, the VoIP server 100 performs the processes of decoding the audio data input from the VoIP terminals 310, 320, 330, mixing the decoded audio data, and encoding the mixed audio data, and the like.

The VoIP server 100 can perform also a fault detecting process, a maintenance process, and the like in addition to the above-described signaling and multimedia processes. The fault detecting process means a process of, when a fault occurs in the VoIP server 100, the network 200, or the like, detecting the fault, and a process of dealing with the fault.

The maintenance process is a process related to, for example, setting of software of the VoIP server 100, performed at, for example, every elapse of a predetermined period.

The signaling process, the multimedia process, and the fault detecting process are requested to have a high real-time property. For example, when the signaling process is delayed, a long time is required for establishing a call between terminals. When the multimedia process is delayed, a sound or a video is hardly transmitted or received in real time. When the fault detecting process is delayed, a fault of the VoIP system is lately found and dealt with. Therefore, these processes should be promptly performed. However, there is a possibility that the process of the CPU may be constrained by, for example, the audio or video codec process of the multimedia process.

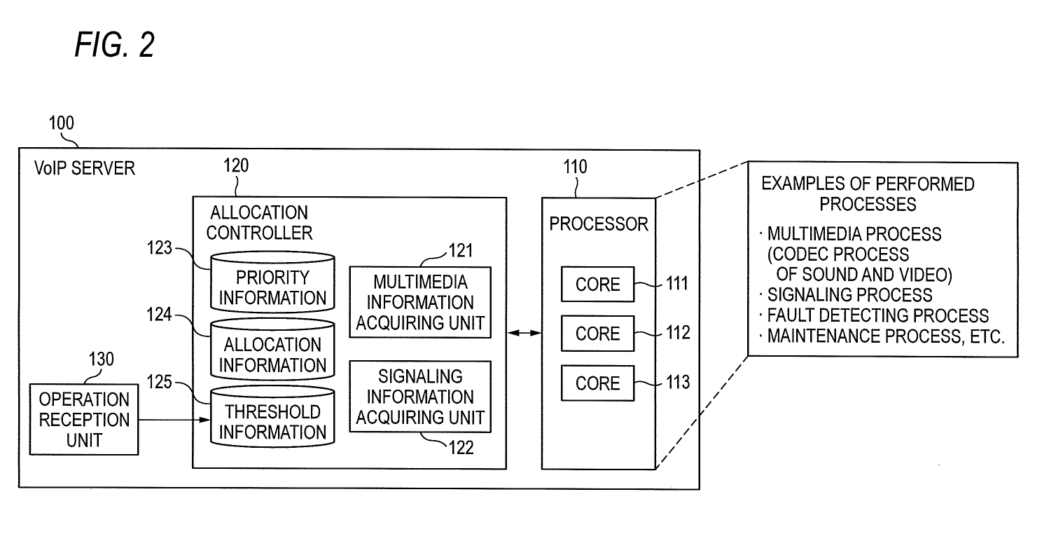

In the VoIP server 100 of the first embodiment, by contrast, a process which is to be performed by the VoIP server 100 is allocated to a plurality of CPU cores, whereby the process loads of the CPU cores can be suppressed. This configuration will be described later in detail with reference to FIGS. 2 to 12.

FIG. 2 is a diagram showing an example of a system configuration of the VoIP server 100 of the first embodiment. The VoIP server 100 includes a CPU 110, an allocation controller 120, an operation reception unit 130, etc. The CPU 110 includes a CPU core 111, a CPU core 112, a CPU core 113, and the like, and has a function of performing the signaling, multimedia, fault detecting, and maintenance processes which are described above, and the like. In the CPU 110, each of the processes is performed by the CPU core which is allocated by the allocation controller 120.

The allocation controller 120 includes a multimedia information acquiring unit 121, a signaling information acquiring unit 122, a priority information database 123, an allocation information database 124, a threshold information database 125, and the like, and has a function of previously allocating CPU cores which are to perform the signaling process, the multimedia process, the fault detecting process, the maintenance process, and the like, and causing the CPU cores to perform these process in accordance with the process state of the CPU cores.

The multimedia information acquiring unit 121 acquires information of the codec process of audio data and video data which are to be processed by the VoIP server 100, and information of the bit rate of the data. The multimedia information acquiring unit 121 acquires codec information and bit rate information which are described in an SDP (Session Description Protocol) contained in, for example, the INVITE signal. The codec information means information of a codec of a sound or video which is transmitted or received in a call, a telephone conference, or the like.

In the case where the VoIP server 100 controls a telephone conference, for example, the multimedia information acquiring unit 121 acquires information of a codec used in the telephone conference, and determines the number of codec processes in the telephone conference. In the telephone conference, namely, the VoIP server 100 decodes audio and video data which are received from VoIP terminals used in the telephone conference, and, in order to encode mixed audio data and the like and then transmit the data to the VoIP terminals, performs decoding/encoding processes the number of which corresponds to that of the VoIP terminals joining the telephone conference. The multimedia information acquiring unit 121 determines the number of the decoding/encoding processes.

The signaling information acquiring unit 122 determines the process number of signaling processes which are to be processed by the VoIP server 100, and the like. Namely, the signaling information acquiring unit 122 counts the number of signals which are transmitted from and received by, for example, the VoIP server, such as the INVITE signal and the 200 OK message. The signaling information acquiring unit 122 may determine the number of signals which are transmitted and received at a certain time, or alternatively may determine both the number of signals which are transmitted and received at a certain time, and that of signals which can be transmitted and received after the signals that are being under the transmission and reception. In the case where a call is made between VoIP terminals, when the VoIP server 100 processes the INVITE signal that is a calling signal from a terminal to another terminal, for example, there is a possibility that the VoIP server 100 may thereafter transmit and receive signals such as the RINGING, the 200 OK, and the ACK, and the signaling information acquiring unit 122 can determine the number of the signals which may be transmitted and received.

The priority information database 123 is a database for giving priority to one of processes such as the signaling process, the multimedia process, the fault detecting process, and the maintenance process. The database may be previously held by the VoIP server 100, or produced by the allocation controller 120 based on a user's input through the operation reception unit 130. Namely, the user may select the process to which the priority is given, from processes such as the signaling process, the multimedia process, the fault detecting process, and the maintenance process.

The allocation information database 124 is a database for allocating such as the signaling process, the multimedia process, the fault detecting process, and the maintenance process to which of the CPU cores of the CPU 110, to cause the processes to be performed. The database is produced by the allocation controller 120 based on the priority information database 123 and the number of the CPU cores of the VoIP server 100. The allocation information database 124 will be described later with reference to FIG. 4.

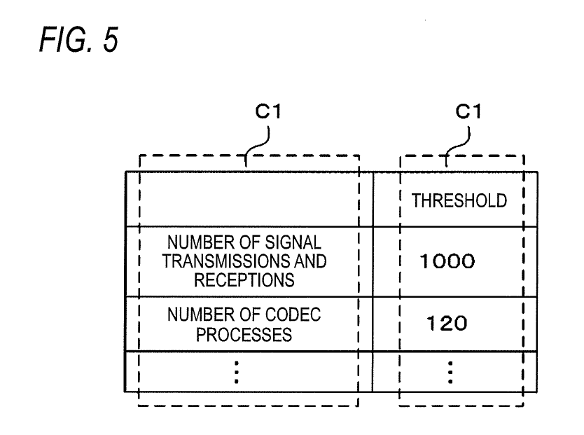

The threshold information database 125 is a database to be referred in the case where the allocation controller 120 allocates a process or the like to which a CPU that is to perform the process is not allocated, to a CPU core in accordance with the process state of the CPU cores of the CPU 110. For example, the usage rates of the CPU cores which are used as a threshold, the number of codec processes, the number of signal transmissions and receptions, and the like are stored in the database. The threshold information database 125 will be described later with reference to FIG. 5.

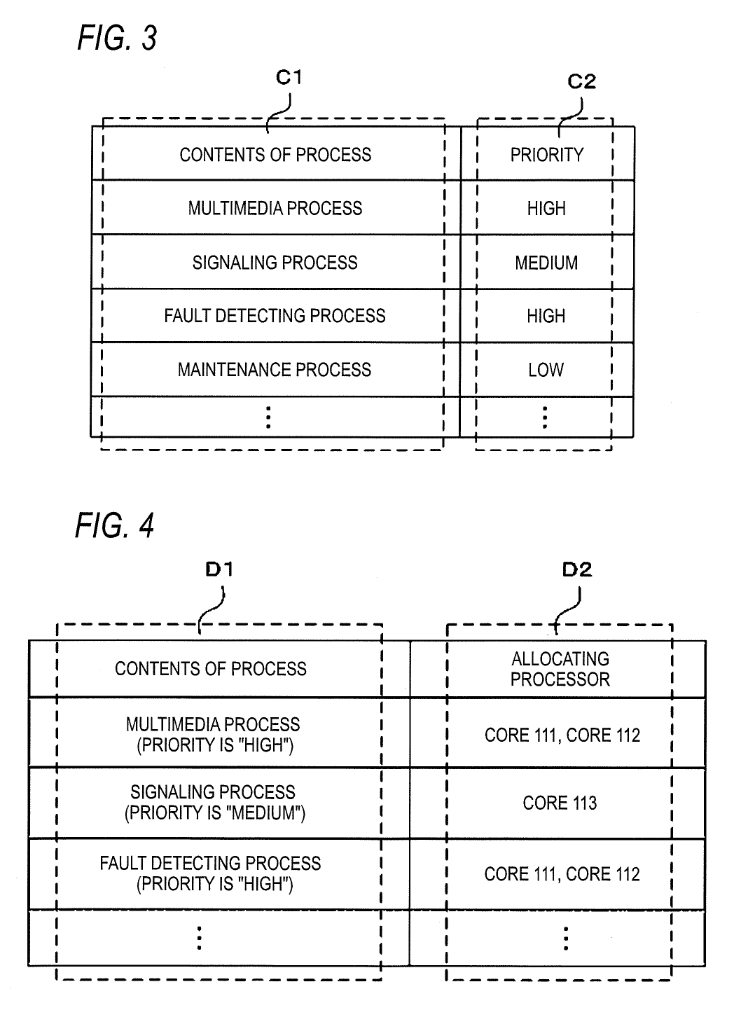

Next, an example of the configuration of the priority information database 123 will be described with reference to FIG. 3. In the priority information database 123, for example, processes which are to be performed by the VoIP server 100, and the priorities of the processes are stored in a correlated manner. As shown in FIG. 3, namely, a list of processes which are to be performed by the VoIP server 100 is stored in the row of C1, and the priorities of the processes are stored in the row of C2 while being correlated with the processes.

Then, an example of the configuration of the allocation information database 124 will be described with reference to FIG. 4. In the allocation information database 124, the processes which are to be performed by the VoIP server 100, and CPU cores of the CPU 110 which are to perform the process are stored in a correlated manner. The allocation information database 124 is produced by the allocation controller 120 based on the priority information database 123 and the CPU information acquired by the allocation controller 120, and a CPU core(s) according to the priority is allocated to each of processes. Namely, the allocation controller 120 acquires CPU information such as the number of cores of the CPU 110, from the CPU, acquires the priorities of the processes, from the priority information database 123, and allocates a CPU core(s) the number of which corresponds to the corresponding priority, to each process. Furthermore, the allocation controller 120 allocates a CPU core(s) the number of which corresponds to the corresponding priority, to each process so that the multimedia process and the signaling process are performed by different CPU cores. In the database shown in FIG. 4, for example, CPU cores the number of which is equal to or larger than that of the signaling process in which the priority is set to “medium” are allocated to the multimedia process and fault detecting process in which the priority is set to “high”, and the processes of “high” priority and those of “medium” priority are allocated to different CPU cores. The allocation information database 124 is not always required to be produced based on the priority information database 123, but requested to be produced so that at least the multimedia process and the signaling process are allocated to different CPU cores.

Next, an example of the data configuration of the threshold information database 125 will be described with reference to FIG. 5. In the database, information which functions as a threshold in the processes to be performed by the VoIP server 100 is stored. In the example shown in FIG. 5, for example, a threshold of 1,000 is correlated to the number of signal transmissions and receptions, and 120 is correlated to the number of codec processes. For example, the number of signal transmissions and receptions is the total sum of the number of signals which are transmitted and received in the currently performed signaling process, and the number of signals which can be transmitted and received in succession to the signals in the transmission and the reception. The number of codec processes is the number of audio data and video data which are encoded/decoded by the VoIP server 100. In a codec process, the VoIP server 100 performs encoding/decoding by means of codec of, for example, G.711 or G.729. Depending on codec, the process load of the CPU is varied. Therefore, a value which is weighted for each codec may be set as the number of codec processes. For example, it is assumed that an encoding/decoding process by G.729 produces a process load which is three times larger than a process load produced by an encoding/decoding process by G.711. In the threshold information database 125, while calculating the following expression of [(number of codec processes by G.729)×3+(number of codec processes by G.711)=number of codec processes], a threshold may be set to the calculated number of codec processes in the threshold information database 125.

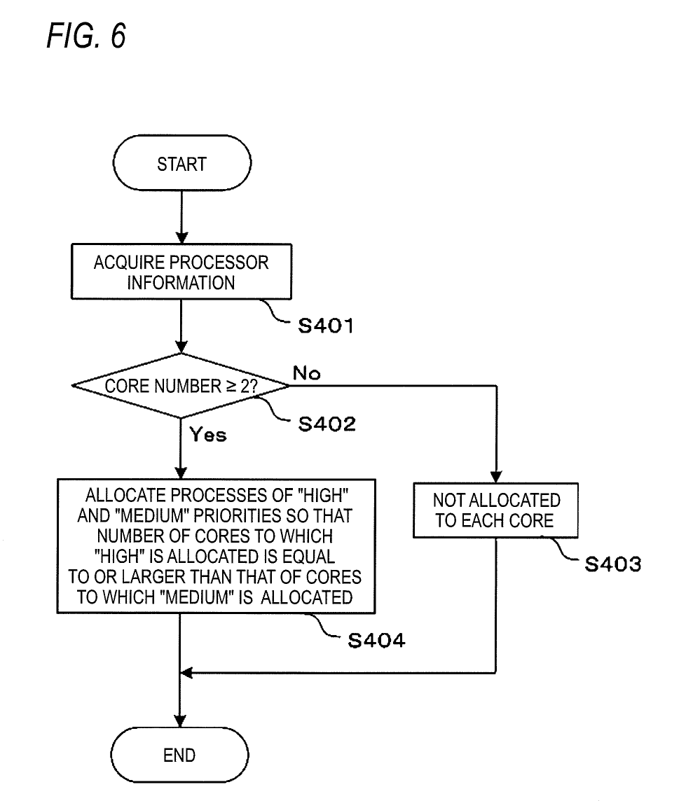

Next, an example of the process flow in which the allocation controller 120 produces the allocation information database 124 will be described with reference to FIG. 6.

First, the allocation controller 120 acquires information of the CPU 110 (S401). Then, the allocation controller 120 determines whether the core number of the CPU is 2 or more or not (S402). If the core number of the CPU is 1 (No in S402), the allocation controller 120 does not allocate the processes to each of the CPU cores, but allocates the processes to the one CPU core (S403). In the case where the core number of the CPU is determined, the allocation controller 120 determines the total number of the cores of the CPU provided in the VoIP server 100. Namely, in the case where the VoIP server 100 includes two CPUs each having a single CPU core, the allocation controller 120 determines that the CPU core number of the VoIP server 100 is 2. The case where, in S402, the core number is 1 means a case where the number of the CPU provided in the VoIP server 100 is 1, and the core number of the CPU is 1.

By contrast, if, in S402, the core number of the CPU is 2 or more (Yes in S402), the allocation controller 120 refers the priority information database 123, allocates CPU cores the number of which is equal to or larger than the number of processes in which the priority is set to “medium”, to processes in which the priority is set to “high”, and stores information of the allocation in the allocation information database 124 (S405). In the first embodiment, the allocation controller 120 does not perform setting/allocation on a CPU core which performs a process in which the priority is set to “low”.

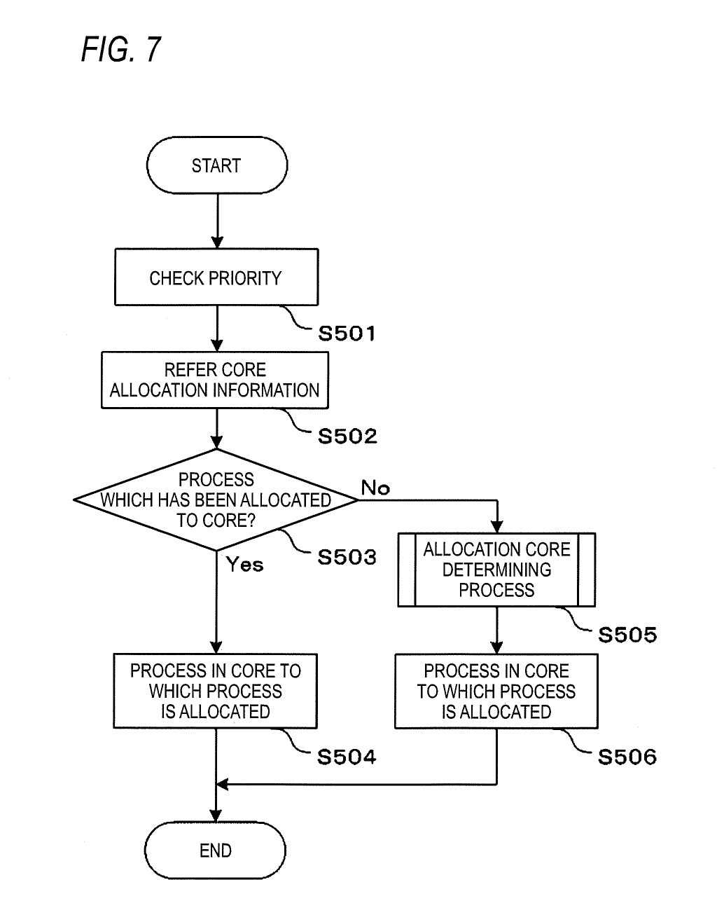

Next, an example of a process flow of an allocating process performed by the allocation controller 120 will be described with reference to FIG. 7.

In the case where the VoIP server 100 is to perform any process, the allocation controller 120 determines which process corresponds to the process to be performed, and checks the priority of the process (S501). The any process excludes the allocating process. Then, the allocation controller 120 refers the allocation information database 124 (S502), and determines whether the process is a process which is allocated to a CPU core or not (S503). If the process is a process which is allocated to a CPU core (Yes in S503), the CPU 110 performs the process in the CPU core to which the process is allocated (S504).

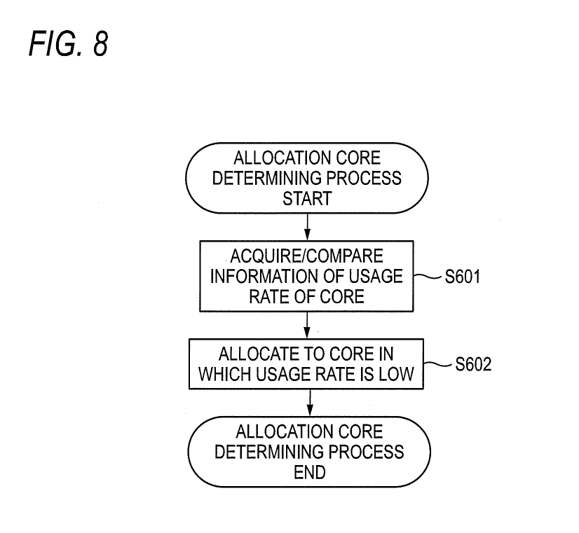

If, in S503, the process to be performed is an unallocated process which is not allocated to a CPU core, the allocation controller 120 performs an allocation CPU core determining process, and allocates the unallocated process to a CPU core according to the process states of the CPU cores of the CPU 110 (S505). The allocation CPU core determining process will be described later in detail with reference to FIGS. 8 to 10. Then, the CPU 110 performs the unallocated process in the CPU core which is allocated in the allocation CPU core determining process of S505 (S506).

Next, an example of a process flow of the allocation CPU core determining process will be described with reference to FIGS. 8 to 10.

FIG. 8 is a chart showing an example of the process flow of the allocation CPU core determining process. In the flow, first, the allocation controller 120 acquires the usage rates of the CPU cores of the CPU 110, and compares the usage rates of the CPU cores (S601). Then, the allocation controller 120 allocates the unallocated process to a CPU core in which the usage rate is low (S602).

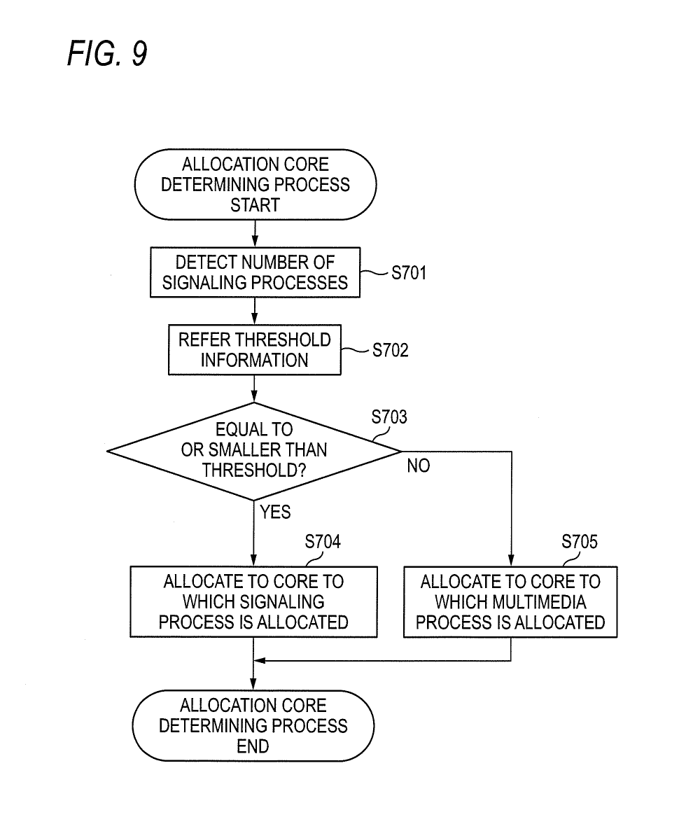

FIG. 9 is a chart showing another example of the process flow of the allocation CPU core determining process. In the flow, first, the signaling information acquiring unit 122 detects the number of signal transmissions and receptions in the signaling process (S701). Then, the allocation controller 120 refers the threshold information database 125, and determines whether the number of signal transmissions and receptions is equal to or smaller than a threshold or not (S703). If the number of signal transmissions and receptions is equal to or smaller than the threshold (Yes in S703), the allocation controller 120 allocates the unallocated process to the CPU core to which the signaling process is allocated. If, in S703, the number of signal transmissions and receptions is larger than the threshold, the allocation controller 120 allocates the unallocated process to a CPU core to which the signaling process is not allocated (S705) by the allocation information database 124. In the first embodiment, the signaling process and the multimedia process are allocated to different CPU cores, and hence the unallocated process is allocated in S705 to the CPU core to which the multimedia process is allocated.

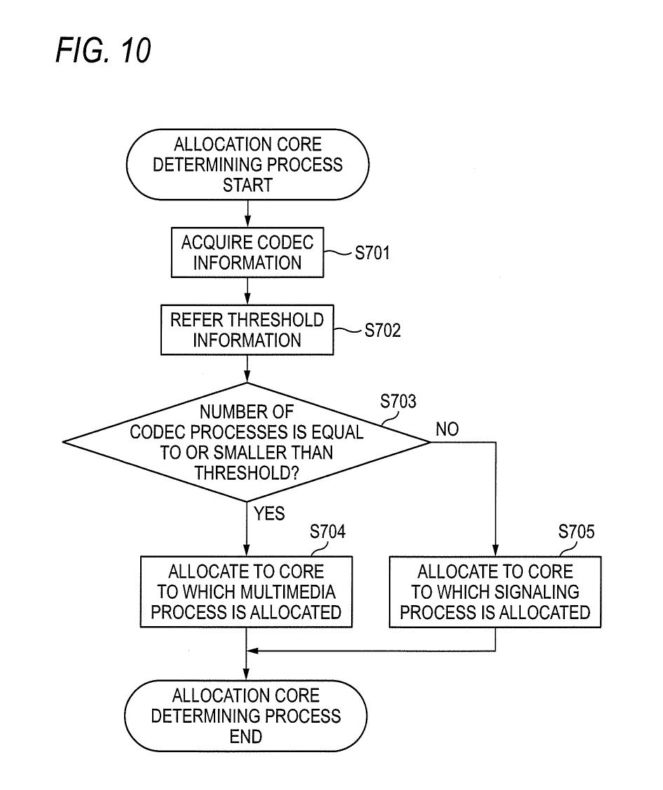

FIG. 10 is a chart showing a further example of the process flow of the allocation CPU core determining process. In the flow, first, the multimedia information acquiring unit 121 acquires information of the number of codec processes with respect to the number of audio and video data which are encoded/decoded by the VoIP server 100 (S701). Then, the allocation controller 120 refers a codec process threshold stored in the threshold information database 125 (S702), and determines whether the number of codec processes is equal to or smaller than the threshold or not (S703). If the number of codec processes is equal to or smaller than the threshold, the allocation controller 120 allocates the unallocated process to the CPU core to which the multimedia process is allocated (S704). If, in S703, the number of the number of codec processes is larger than the threshold (No in S703), the allocation controller 120 allocates the unallocated process to a CPU core to which the multimedia process is not allocated by the allocation information database 124 (S705). In the embodiment, the multimedia process and the signaling process are allocated to different CPU cores, and hence the unallocated process is allocated in S705 to the CPU core to which the signaling process is allocated.

According to the first embodiment, the VoIP server 100 allocates the multimedia process and the signaling process to different CPU cores, whereby the processes can be suppressed from mutually constraining the processes, and, in accordance with the process states of the CPU cores to which the multimedia process and the signaling process are allocated, processes which are different from the multimedia process and the signaling process can be allocated to the CPU cores to be performed. Therefore, the process loads of the CPU cores due to the different processes can be suppressed. In a system of a VoIP server and VoIP terminals, consequently, a stable real-time property can be maintained.

It has been described that, in the embodiment, the CPU 110 of the VoIP server 100 has a plurality of CPU cores. However, the embodiment can be implemented also in the case where, for example, the VoIP server 100 includes a plurality of CPUs each having a single CPU core. In this case, the allocation controller 120 can allocate various processes to the CPU cores disposed respectively in the plurality of CPUs.

In accordance with the process state of the multimedia process, furthermore, the VoIP server 100 can allocate a part of processes which are different from the multimedia process and the signaling process, to one of the different CPU cores to which the multimedia process and the signaling process are allocated, to perform the part. According to the configuration, the VoIP server 100 can easily determine the process state of the CPU core by means of, for example, counting the number of encoding/decoding processes.

In accordance with the process state of the signaling process, furthermore, the VoIP server 100 can allocate a part of processes which are different from the signaling process and the multimedia process, to one of the different CPU cores to which the signaling process and the multimedia process are allocated, to perform the part. According to the configuration, the VoIP server 100 can easily determine the process state of the CPU core by means of, for example, counting the number of signaling processes.

Moreover, the VoIP server 100 can determine one process to which priority is given, from the multimedia process and the signaling process, and allocate CPU cores the number of which is equal to or larger than that of CPU cores for the other process, to the process which is determined to have priority. According to the configuration, the VoIP server 100 can suppress the rise of the process load of the process to which priority is to be given.

### Second Embodiment

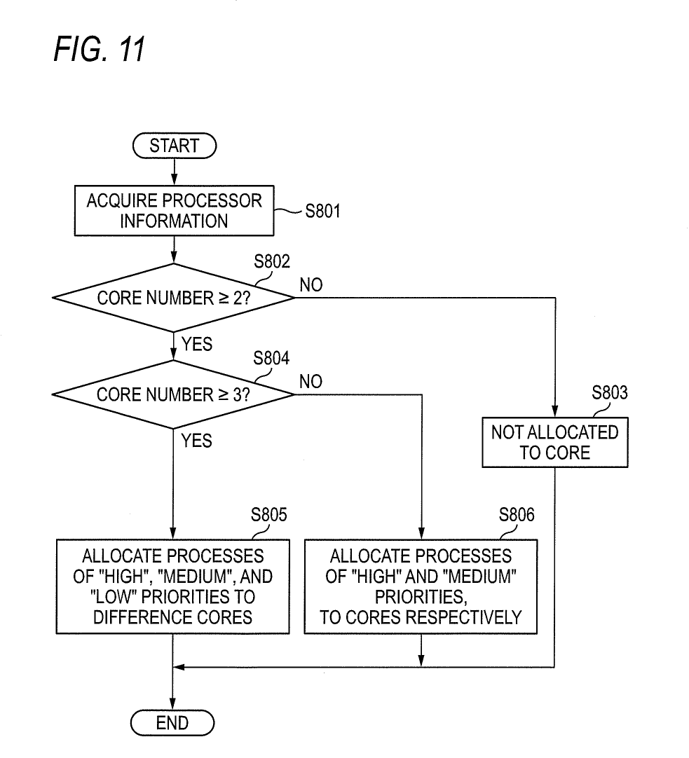

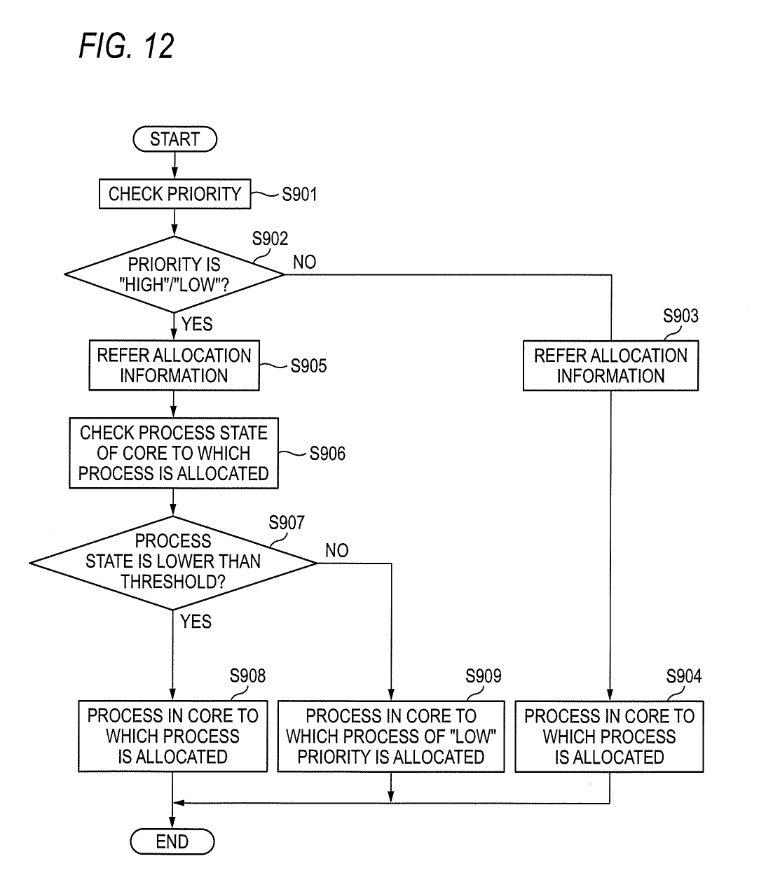

A second embodiment will be described with reference to FIGS. 11 and 12. In the second embodiment, in the case where the number of CPU cores of the VoIP server 100 is 3 or more, the VoIP server 100 previously allocates the multimedia process, the signaling process, and a process which is different from the multimedia process and the signaling process, to different CPU cores, and, in accordance with the process states of the multimedia process and signaling process, and the like, allocates the multimedia process and signaling process to a CPU core to cause the processes to be performed. In the second embodiment, the system configuration of the VoIP server 100, the priority information database 123, the allocation information database 124, the threshold information database 125, and the like are identical with those of the first embodiment. Therefore, their description is omitted.

FIG. 11 shows an example of a process flow of production performed by the VoIP server 100 of the second embodiment, and related to an allocation information database for various processes.

First, the allocation controller 120 acquires CPU information to check the numbers of CPUs and CPU cores disposed in the VoIP server 100 (S801), and determines whether the number of CPU cores is two or more or not (S802). If the CPU core number is 1 (No in S802), the allocation controller 120 does not perform a process of allocating processes to CPU cores, but allocates processes to the single CPU core (S803). By contrast, if the number of CPU cores is two or more (Yes in S802), the allocation controller 120 then determines whether the number of CPU cores is three or more or not (S804). If the number of CPU cores is three or more (Yes in S804), the allocation controller 120 refers the priority information database 123, allocates processes in which their priorities are set to “high”, “medium”, and “low”, respectively, to different CPU cores, respectively, and stores information of the allocation in the allocation information database 124 (S805). In the allocation, the multimedia process is allocated to different CPU cores from the signaling process. If the number of CPU cores is two (No in S804), the allocation controller 120 respectively separately allocates a process of “high” priority and a process of “medium” priority to the two CPU cores, and stores information of the allocation in the allocation information database 124 (S806).

Next, an example of a process flow of a process of allocating processes in the VoIP server 100 of the second embodiment will be described with reference to FIG. 12. The process flow is performed in the case where it is determined in the flow of FIG. 11 that the number of CPU cores is three or more, and processes are respectively allocated to the three or more CPU cores.

In the case where the VoIP server 100 performs any process, the allocation controller 120 determines which process corresponds to the process to be performed, and checks the priority of the process (S901). If the priority of the process is set to “low” (No in S902), the allocation controller 120 refers the allocation information database 124 (S903), and the CPU 110 performs the process in the CPU core to which the process is allocated (S904).

By contrast, if the priority of the process to be performed is set to “high” or “medium” (Yes in S902), the allocation controller 120 refers the allocation information database 124 (S905), and checks the process state of the CPU core to which the process is allocated (S906). In S907, the allocation controller 120 determines whether the process state of the CPU core to which the process to be performed is allocated is equal to or lower than a preset threshold or not (S907).

In S906 and S907, if the process to be performed is the multimedia process, the allocation controller 120 checks the CPU core usage rate of the CPU core to which the multimedia process is allocated, or the number of codec processes, and determines whether the usage rate or the number of codec processes is equal to lower than the threshold or not. In 5906 and S907, if the process to be performed is the signaling process, the allocation controller 120 checks the CPU core usage rate of the CPU core to which the signaling process is allocated, or the number of signal transmissions and receptions in the signaling process, and determines whether the usage rate or the number of signal transmissions and receptions is equal to lower than the preset threshold or not.

If, in S907, the process state of the CPU core is equal to or lower than the threshold (Yes of S907), the allocation controller 120 sets the process so as to be performed in a previously allocated CPU core, and the CPU 110 performs the process in the previously allocated CPU core (S908). In S907, for example, if the process state of the CPU core is higher than the threshold (No of S907), the allocation controller 120 allocates the process to a CPU core to which “low” priority is allocated, and the CPU 110 performs the process in the allocated CPU core (S909).

According to the second embodiment, the VoIP server 100 allocates the multimedia process and the signaling process to different CPU cores, respectively, whereby the processes can be suppressed from mutually constraining the processes, and, in accordance with the process states of the CPU cores to which the multimedia process and the signaling process are allocated, at least a part of the multimedia process and the signaling process can be allocated to a CPU core that is different from the CPU cores to which these processes are allocated, to be performed. According to the configuration, the process loads of the CPU cores due to the multimedia process and the signaling process can be suppressed.

The VoIP server 100 can easily determine the process state of a CPU core by means of, for example, counting the number of encoding/decoding processes or that of signaling processes, and, according to the process state of the CPU core, allocate the multimedia process and the signaling process to a CPU core to cause the processes to be performed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus which performs a signaling process with an external apparatus through a network and a multimedia process of data, comprising:
first and second CPU cores each including one or more CPU cores;
a first controller configured to allocate one of the signaling process and the multimedia process to the first CPU core, and the other of the signaling process and the multimedia process to the second CPU core; and
a second controller configured to allocate a process which is different from the multimedia process and the signaling process to one of the first and second CPU cores, according to process states of the first and second CPU cores.

2. The apparatus of claim 1, wherein,
the second controller is configured to allocate the different process to one of the first and second CPU cores according to a process state of the multimedia process allocated to the first or second CPU core.

3. The apparatus of claim 2, wherein,
the second controller is configured to allocate the different process to one of the first and second CPU cores according to a process state of a codec process allocated to the first or second CPU core.

4. The apparatus of claim 1, wherein,
the second controller is configured to allocate the different process to one of the first and second CPU cores according to a process state of the signaling process allocated to the first or second CPU core.

5. The apparatus of claim 1 further comprising:
a determining module configured to determine one of the signaling process and the multimedia process, as a process to which a priority is given, wherein
a CPU core number of the first CPU core is equal to or larger than a CPU core number of the second CPU core, and
the first controller is configured to allocate the process to which the priority is given, to the first CPU core, and to allocate another process to the second CPU core.

6. An information processing apparatus which performs a signaling process with an external apparatus through a network and a multimedia process of data, comprising:
first, second and third CPU cores each including one or more CPU cores;
a first controller configured to allocate one of the signaling process and the multimedia process to the first CPU core, the other of the signaling process and the multimedia process to the second CPU core, and a process which is different from the signaling process and the multimedia process to the third CPU core; and
a second controller configured to allocate, to the third CPU core, a part of the process which is allocated to the first CPU core, according to a process state of the first CPU core.

7. The apparatus of claim 6, wherein,
in a case where the multimedia process is allocated to the first CPU core, the second controller is configured to allocate a part of the multimedia is process to the third CPU core according to a process state of the multimedia process.

8. The apparatus of claim 7, wherein,
according to a process state of a codec process allocated to the first CPU core, the second controller is configured to allocate a part of the codec process to the third CPU core.

9. The apparatus of claim 6, wherein,
in a case where the signaling process is allocated to the first CPU core, the second controller is configured to allocate a part of the signaling process to the third CPU core according to a process state of the signaling process.

10. The apparatus of claim 6, wherein,
the second controller is configured to allocate, to the third CPU core, a part of the process allocated to the second CPU core according to a process state of the second CPU core.

11. The apparatus of claim 6 further comprising:
a determining module configured to determine one of the signaling process and the multimedia process, as a process to which a priority is given, wherein
a CPU core number of the first CPU core is equal to or larger than a CPU core number of the second CPU core, and
the first controller is configured to allocate the process to which the priority is given, to the first CPU core, and to allocate another process to the second CPU core.
